(19) United States
(12) Patent Application Publication
(10) Pub. No.: US 2025/0185724 A1
(43) Pub. Date: Jun. 12, 2025

(54) ELECTRONIC ATOMIZATION APPARATUS AND CONTROL METHOD FOR ELECTRONIC ATOMIZATION APPARATUS

(71) Applicant: SHENZHEN FIRST UNION TECHNOLOGY CO., LTD., Shenzhen, Guangdong (CN)

(72) Inventors: Hanliang CHEN, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 18/845,931

(22) PCT Filed: Mar. 9, 2023
(86) PCT No.: PCT/CN2023/080584

§ 371 Date: Sep. 11, 2024

(30) Foreign Application Priority Data
Mar. 11, 2022 (CN) 202210239470.8

(51) Int. Cl. A24F 40/57; A24F 40/10; A24F 40/53; H05B 1/02

(52) U.S. Cl. CPC A24F 40/57; A24F 40/10; A24F 40/53; H05B 1/0252

(57) ABSTRACT

An electronic atomization apparatus and a control method are provided. The electronic atomization apparatus is controlled by a controller to power a heating element, so that the heating element heats a liquid substrate at a constant target temperature. The controller is configured to periodically and repeatedly perform a control step to control the power provided by a battery cell directly or indirectly to the heating element. The control step includes: determining a preset target temperature; determining, based on a current temperature of the heating element or a difference between the current temperature and the target temperature, power required for the heating element to be heated to the target temperature or maintain the target temperature within a predetermined time period of a single cycle; and controlling the battery cell to directly or indirectly output the required power to the heating element until the predetermined time period ends.

### CROSS-REFERENCE TO RELATED APPLICATIONS

This application claims priority to Chinese Patent Application No. 202210239470.8, filed with the China National Intellectual Property Administration on Mar. 11, 2022 and entitled “ELECTRONIC ATOMIZATION APPARATUS AND CONTROL METHOD FOR ELECTRONIC ATOMIZATION APPARATUS”, which is incorporated herein by reference in its entirety.

### TECHNICAL FIELD

Embodiments of this application relate to the field of electronic atomization technologies, and in particular, to an electronic atomization apparatus and a control method for the electronic atomization apparatus.

### BACKGROUND

Tobacco products (for example, cigarettes and cigars) burn tobacco during use to produce tobacco smoke. Attempts are made to replace these tobacco-burning products by manufacturing products that release compounds without burning.

An example of such a product is an electronic atomization product, which vaporizes a liquid substrate by heating the liquid substrate, thereby generating an inhalable vapor or an aerosol. The liquid substrate may include nicotine, and/or aromatics, and/or aerosol-generating substances (for example, glycerin). In a known electronic atomization product, a battery cell directly outputs power to a resistance heating element through on/off of a switch transistor, so that the liquid substrate is heated and atomized to generate an aerosol. For control during a heating process, CN112189907A provides a typical output control method, to control, in a constant power output manner, power provided to the resistance heating element to heat the liquid substrate. Therefore, during heating, a temperature of the resistance heating element needs to be detected in real time, to prevent “dry burning” caused by the temperature of the resistance heating element increasing above a target temperature in constant power output.

### SUMMARY

An embodiment of this application provides an electronic atomization apparatus, including: a liquid storage cavity, configured to store a liquid substrate;
a heating element, configured to heat the liquid substrate to generate an aerosol for inhalation;
a battery cell, configured to provide a power output; and
a controller, configured to periodically and repeatedly perform a control step, to control the battery cell to directly or indirectly provide power to the heating element, to cause the heating element to heat the liquid substrate, where the control step includes:
determining a preset target temperature;
obtaining a current temperature of the heating element, and determining, based on the current temperature of the heating element or a difference between the current temperature and the target temperature, power required for the heating element to be heated to the target temperature or maintain the target temperature within a predetermined time period of a single cycle; and
controlling the battery cell to directly or indirectly output the required power to the heating element until the predetermined time period ends, where
the target temperature is constant or unchanged during a process in which the control step is repeatedly performed.

In a more preferred implementation, the electronic atomization apparatus further includes:
a first switch transistor, where the battery cell directly or indirectly provides power to the heating element through the switch transistor; and
the controlling the battery cell to directly or indirectly output the required power to the heating element includes: determining required turn-on time of the first switch transistor within the predetermined time period based on the required power, and controlling turn-on or turn-off of the first switch transistor based on the required turn-on time.

In a more preferred implementation, the target temperature ranges from 150° C. to 300° C.

In a more preferred implementation, the predetermined time period ranges from 1 ms to 100 ms.

In a more preferred implementation, the controller is configured to:
control, in a first heating time period, the battery cell to provide power to the heating element, to heat a temperature of the heating element from an initial temperature to the target temperature; and
maintain, in a second heating time period, the temperature of the heating element at the target temperature.

In a more preferred implementation, the controller is configured to repeatedly perform the control step at a first frequency in the first heating time period, and repeatedly perform the control step at a second frequency in the second heating time period, where
the first frequency is greater than the second frequency.

In a more preferred implementation, a predetermined time period during which the control step is performed in the first heating time period is less than a predetermined time period during which the control step is performed in the second heating time period.

In a more preferred implementation, the controller is configured to control power provided by the battery cell to the heating element in the first heating time period to be greater than power provided to the heating element in the second heating time period.

In a more preferred implementation, the predetermined time period during which the control step is performed in the first heating time period ranges from 1 ms to 20 ms; and/or the predetermined time period during which the control step is performed in the second heating time period ranges from 20 ms and 100 ms.

In a more preferred implementation, the controller is further configured to: determine an adverse condition based on the power provided by the battery cell to the heating element; and prevent the battery cell from providing power to the heating element when the adverse condition exists.

In a more preferred implementation, the controller is configured to determine, based on the power provided by the battery cell to the heating element being less than a preset threshold, that the liquid substrate provided to the heating element is insufficient or exhausted. In a more preferred implementation, the controller is configured to obtain the current temperature of the heating element by detecting a resistance value of the heating element.

In a more preferred implementation, the electronic atomization apparatus further includes:
a standard voltage divider resistor; and
a second switch transistor, operably connecting the standard voltage divider resistor and the heating element to form a detectable loop in series, where
the controller is configured to detect an electrical characteristic of the standard voltage divider resistor and/or the heating element in the detectable loop, to obtain the current temperature of the heating element.

In a more preferred implementation, the electronic atomization apparatus further includes: a boost unit, configured to boost an output voltage of the battery cell.

In a more preferred implementation, the controller is configured to control the turn-on and turn-off of the first switch transistor through pulse width modulation; and
in the control step, the controller is configured to adjust, based on the required turn-on time, a duty cycle of the pulse width modulation to control the turn-on and turn-off of the first switch transistor.

In a more preferred implementation, the power provided by the battery cell to the heating element is variable or non-constant.

Another embodiment of this application further provides a control method for an electronic atomization apparatus. The electronic atomization apparatus includes:
a liquid storage cavity, configured to store a liquid substrate;
a heating element, configured to heat the liquid substrate to generate an aerosol for inhalation;
a battery cell, configured to provide a power output; and
the method includes:
periodically and repeatedly performing a control step, to control the battery cell to directly or indirectly provide power to the heating element, to cause the heating element to heat the liquid substrate, where the control step includes:
determining a preset target temperature;
obtaining a current temperature of the heating element, and determining, based on the current temperature of the heating element or a difference between the current temperature and the target temperature, power required for the heating element to be heated to the target temperature or maintain the target temperature within a predetermined time period of a single cycle; and
controlling the battery cell to directly or indirectly output the required power to the heating element until the predetermined time period ends, where
the target temperature is constant or unchanged during a process in which the control step is repeatedly performed.

Another embodiment of this application further provides a controller, including:
at least one processor; and
a memory communicatively connected to the at least one processor, where
the memory stores instructions executable by the at least one processor, and the instructions are executed by the at least one processor, to cause the at least one processor to be capable of performing the method described above.

Another embodiment of this application further provides a non-volatile computer-readable storage medium, where the computer-readable storage medium stores computer executable instructions, when executed by a controller, causing the controller to perform the method described above.

Another embodiment of this application further provides a computer program product, including a computer program stored in a non-volatile computer-readable storage medium, the computer program including program instructions, the program instructions, when executed by a controller, causing the controller to perform the method described above.

In the foregoing electronic atomization apparatus, power is provided in a constant temperature control mode, which is faster than a normal constant power output control mode in heating from the initial temperature to the target temperature, and is beneficial for generating an aerosol quickly.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an electronic atomization apparatus according to an embodiment;

FIG. 2 is a schematic diagram of an embodiment of an atomizer in FIG. 1;

FIG. 3 is a schematic diagram of a porous body in FIG. 2 from a perspective;

FIG. 4 is a schematic diagram of a porous body in FIG. 2 from another perspective;

FIG. 5 is a schematic diagram of another embodiment of an atomizer in FIG. 1;

FIG. 6 is a structural block diagram of an embodiment of a circuit board in FIG. 1;

FIG. 7 is a schematic diagram of a standard voltage divider resistor and a heating element in FIG. 6 forming a detectable loop;

FIG. 8 is a schematic diagram of a preset heating curve for controlling a heating element according to an embodiment;

FIG. 9 is a schematic diagram of a control step for controlling power provided to a heating element according to an embodiment;

FIG. 10 is a schematic diagram of a resistance change curve of a heating element during heating based on a preset heating curve according to an embodiment and a comparative example;

FIG. 11 is a schematic diagram of an electronic atomization apparatus according to another embodiment;

FIG. 12 is a schematic diagram of an atomization assembly according to another embodiment; and

FIG. 13 is a schematic diagram of a hardware structure of a controller according to another embodiment.

### DETAILED DESCRIPTION

For ease of understanding this application, this application is described below in more detail with reference to accompanying drawings and specific implementations.

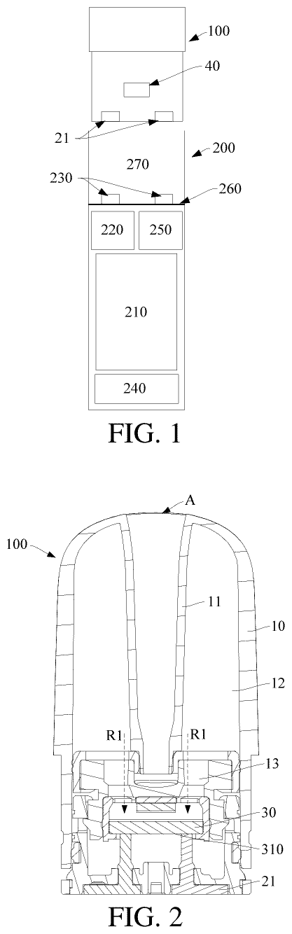

This application provides an electronic atomization apparatus. Referring to FIG. 1, the electronic atomization apparatus includes: an atomizer 100, configured to store a liquid substrate and heat and atomize the liquid substrate to generate an aerosol; and a power supply mechanism 200, configured to supply power to the atomizer 100.

In an optional implementation, as shown in FIG. 1, the power supply mechanism 200 includes: a receiving cavity 270, arranged at an end in a length direction and configured to receive and accommodate at least a part of the atomizer 100; and a first electrical contact 230, at least partially exposed on a surface of the receiving cavity 270. The first electrical contact 230 is configured to be electrically connected to the atomizer 100 to supply power to the atomizer 100 when at least a part of the atomizer 100 is received and accommodated in the receiving cavity 270.

According to a preferred implementation shown in FIG. 1, an end portion of the atomizer 100 opposite to the power supply mechanism 200 in the length direction is provided with a second electrical contact 21, so that when at least a part of the atomizer 100 is received in the receiving cavity 270, the second electrical contact 21 forms conductivity through being in contact with and abutting against the first electrical contact 230.

A sealing member 260 is arranged inside the power supply mechanism 200, and at least a part of an internal space of the power supply mechanism 200 is separated through the sealing member 260 to form the receiving cavity 270. In the preferred implementation shown in FIG. 1, the sealing member 260 is configured to extend in a cross section direction of the power supply mechanism 200, and is preferably prepared by using a flexible material such as silica gel, so as to prevent the liquid substrate seeping from the atomizer 100 to the receiving cavity 270 from flowing to components such as a circuit board 220 and an airflow sensor 250 inside the power supply mechanism 200.

In the preferred implementation shown in FIG. 1, the power supply mechanism 200 further includes a battery cell 210, arranged facing away from the receiving cavity 270 in the length direction, and configured to supply power; and a circuit board 220, arranged between the battery cell 210 and an accommodating cavity, and operably guiding a current between the battery cell 210 and the first electrical contact 230.

The power supply mechanism 200 includes an airflow sensor 250, for example, a microphone and a pressure sensor, configured to sense an inhalation flow generated when a user inhales using the atomizer 100, so that the circuit board 220 controls the battery cell 210 to output the power to the atomizer 100 based on a detection signal of the airflow sensor 250. Further, in the preferred implementation shown in FIG. 1, a charging interface 240 is arranged on another end of the power supply mechanism 200 facing away from the receiving cavity 270, and is configured to supply power to the battery cell 210.

The embodiments in FIG. 2 to FIG. 4 show a schematic structural diagram of an embodiment of the atomizer 100 in FIG. 1. The atomizer 100 includes: a main housing 10, a porous body 30, and a heating element 40.

According to FIG. 2, the main housing 10 is generally in a flat cylindrical shape. Certainly, an interior of the main housing 10 is hollow, and is configured to store and atomize the liquid substrate and accommodate another necessary functional device. An upper end of the main housing 10 is provided with a suction nozzle A configured for inhaling an aerosol.

The interior of the main housing 10 is provided with a liquid storage cavity 12 configured to store the liquid substrate. In a specific implementation, a vapor conveying tube 11 is arranged in the main housing 10 in an axial direction, and the liquid storage cavity 12 for storing the liquid substrate is formed in a space between an outer wall of the vapor conveying tube 11 and an inner wall of the main housing 10. An upper end of the vapor conveying tube 11 opposite a near end 110 is in communication with the suction nozzle A.

The porous body 30 is configured to obtain the liquid substrate in the liquid storage cavity 12 through a liquid channel 13. Transfer of the liquid substrate is shown by arrows R1 in FIG. 2. The porous body 30 has a flat atomization surface 310. The heating element 40 for heating at least a part of the liquid substrate absorbed by the porous body 30 to generate an aerosol is formed on the atomization surface 310.

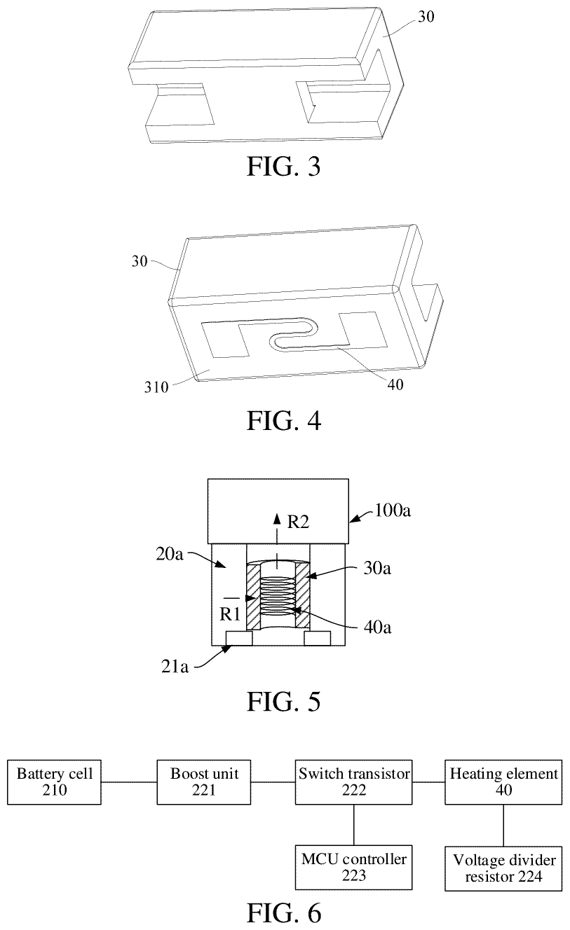

Specifically, referring to FIG. 3 and FIG. 4, a side of the porous body 30 facing away from the atomization surface 310 is in fluid communication with the liquid channel 13 to absorb the liquid substrate, and then the liquid substrate is transferred to the atomization surface 310 for heating and atomizing.

After assembly, both ends of the heating element 40 abut against the second electrical contact 21 to be electrically conductive. The heating element 40 heats at least a part of the liquid substrate of the porous body 30 to generate the aerosol in a turn-on process. In an optional implementation, the porous body 30 includes flexible fibers such as cotton fibers, non-woven fabrics, and glass fiber ropes, or includes porous ceramic with a microporous structure, such as porous ceramics in a shape shown in FIG. 3 and FIG. 4.

The heating element 40 may be combined on the atomization surface 310 of the porous body 30 by printing, deposition, sintering, physical assembly, or the like. In some other variation implementations, the porous body 30 may have a plane or curved surface for supporting the heating element 40, and the heating element 40 is formed on the plane or curved surface of the porous body 30 by mounting, printing, deposition, or the like.

The heating element 40 is made of a metal material with appropriate impedance, a metal alloy, graphite, carbon, conductive ceramic, or another composite material of a ceramic material and a metal material. A suitable metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-chromium-aluminum alloy, titanium alloy, iron-manganese-aluminum based alloy, or stainless steel. A metal or an alloy material with a suitable temperature coefficient of resistance, for example, a positive temperature coefficient or a negative temperature coefficient, may be selected as a resistive material of the heating element 40, so that a heating line can be used both for generating heat and as a sensor for sensing a real-time temperature of the atomization assembly.

FIG. 5 is a schematic structural diagram of an atomizer 100a according to another embodiment. The porous body 30a is configured in a shape of a hollow column extending in a longitudinal direction of the atomizer 100a, and the heating element 40a is formed in the column hollow of the porous body 30a. During use, as shown by arrows R1, the liquid substrate of the liquid storage cavity 20a is absorbed along an outer surface in a radial direction of the porous body 30a, and then transferred to the heating element 40a on an inner surface and heated and evaporated to generate an aerosol. The generated aerosol is outputted from the column hollow interior of the porous body 30a in the longitudinal direction of the atomizer 100a.

In some typical implementations, the heating element 40/40a may have an initial resistance value of approximately 0.3 Ω to 1.5 Ω.

Further, to enable the power supply mechanism 200 to monitor and control a heating process of the heating element 40/40a, a hardware structure of a circuit board 220 of the power supply mechanism 200 in an embodiment is shown in FIG. 6. The circuit board 220 includes:
a boost unit 221, configured to boost a voltage outputted by the battery cell 210 and output the voltage. The boost unit 221 boosts a value of an output voltage, and a voltage value outputted after the boosting is stable, to avoid a situation in which the output voltage of the battery cell 210 gradually decreases or is unstable in a discharging process.

In some implementations, the boost unit 221 is a commonly used boost chip, for example, a boost chip of a micro-source semiconductor LP6216B6F, and can convert a voltage (approximately in a range of 3.7 V to 4.5 V) outputted by the battery cell 210 into a standard voltage output of 6.0 V.

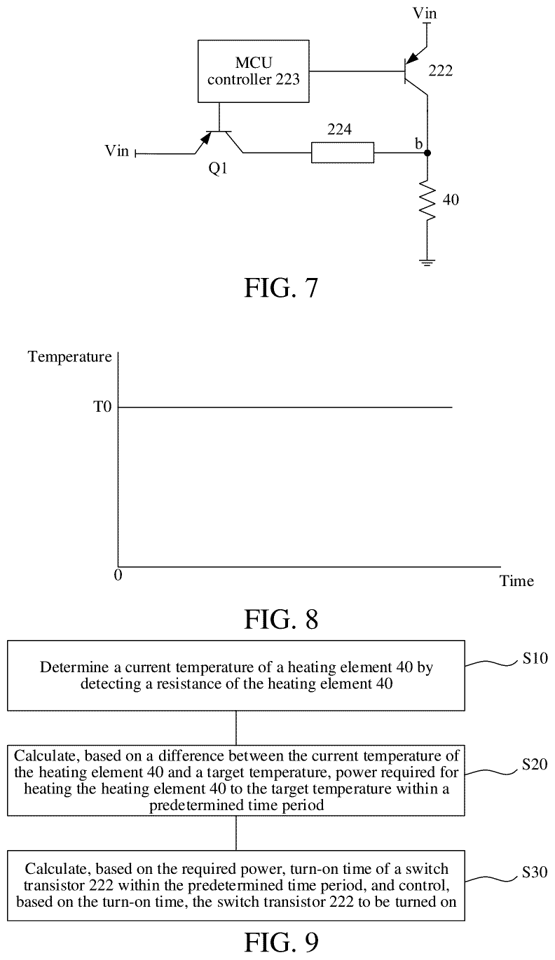

Further, the circuit board 220 further includes:
a switch transistor 222, configured to guide a current between the heating element 40 and the boost unit 221, that is, power the heating element 40;
an MCU controller 223, configured to control power provided to the heating element 40 by controlling turn-on or turn-off of the switch transistor 222; and
a standard voltage divider resistor 224, configured to form a detection loop with the heating element 40, so as to allow the MCU controller 223 to detect an electrical characteristic parameter of the heating element 40. The electrical characteristic parameter usually includes a voltage, a current, a resistance, and the like of the heating element 40. Then, the MCU controller 223 obtains a temperature of the heating element 40 based on a sampled electrical characteristic. For example, based on a correlation between the resistance and the temperature of the heating element 44 with a given resistance, the MCU controller 223 may obtain, through calculation, a real-time temperature of the heating element 44 by detecting the resistance of the heating element 40. Further, specifically, FIG. 7 is a schematic diagram of a standard voltage divider resistor 224 and a heating element 40 forming a detection loop according to an embodiment. During heating, the MCU controller 223 controls the turn-on of the switch transistor 222 to provide power to the heating element 40. During detection, the MCU controller 223 turns off the switch transistor 222 and turns on an MOS tube Q1. A voltage at a site b is sampled between the standard voltage divider resistor 224 and the heating element 40 connected in series, the electrical characteristic such as the resistance of the heating element 40 may be calculated according to a voltage division formula, and then the temperature of the heating element 40 may be obtained through calculation. That is, outputting power to the heating element 40 and detecting the electrical characteristic or the temperature of the heating element 40 are not simultaneously performed.

Further, FIG. 8 is a schematic diagram of a heating curve for controlling a heating element 40 to heat based on a target temperature according to an embodiment. In this embodiment, a target temperature T0 of the heating element 40 is controlled to be constant. The MCU controller 223 controls to provide power to the heating element 40 based on a mode in which the target temperature T0 is constant. In an implementation, the target temperature T0 is higher than a minimum atomization temperature of the liquid substrate, so that the heating temperature of the heating element 40 can reach a temperature required for atomizing the liquid substrate. In some specific implementations, it is appropriate that the target temperature T0 suitable for the liquid substrate may be set to 150° C. to 300° C. More preferably, the target temperature T0 suitable for the liquid substrate may be set to 200° C. to 280° C.

In a specific embodiment, the target temperature T0 determined in the foregoing control step is pre-stored by a memory unit in the MCU controller 223. Alternatively, in another specific embodiment, the target temperature T0 determined in the foregoing control step is inputted by a user through an input element such as an input button or an interaction screen on the electronic atomization apparatus. Alternatively, in another specific implementation, the target temperature T0 determined in the foregoing control step is stored by a manufacturer based on a type of the liquid substrate by arranging a readable storage unit (for example, an EEPROM memory) in the atomizer 100 during production. Then, when the atomizer 100 is received in the power supply mechanism 200, the MCU controller 223 reads the readable storage unit in the atomizer 100 to obtain the target temperature T0.

Further, in the foregoing control method, power is always controlled to be provided based on the constant target temperature T0. In this case, regardless of an amount of the liquid substrate transferred to the heating element 40, the heating element 40 cannot be heated above a high dry-burning temperature at which a hazardous substance is generated, which is beneficial for preventing dry burning.

Further, during heating of the electronic atomization apparatus, heating duration of the heating element 40 is determined by inhalation time of the user sensed by the airflow sensor 250. That is, when the airflow sensor 250 senses inhalation of the user, the MCU controller 223 controls the heating element 40 to heat based on the target temperature T0. When the airflow sensor 250 senses that an inhalation action of the user stops, an output of the power is stopped and heating is stopped. In this case, the heating duration of the heating element 40 is determined based on inhalation duration of the user sensed by the airflow sensor 250. For example, in some conventional implementations, inhalation duration of the user each time approximately ranges from 3 s to 5 s.

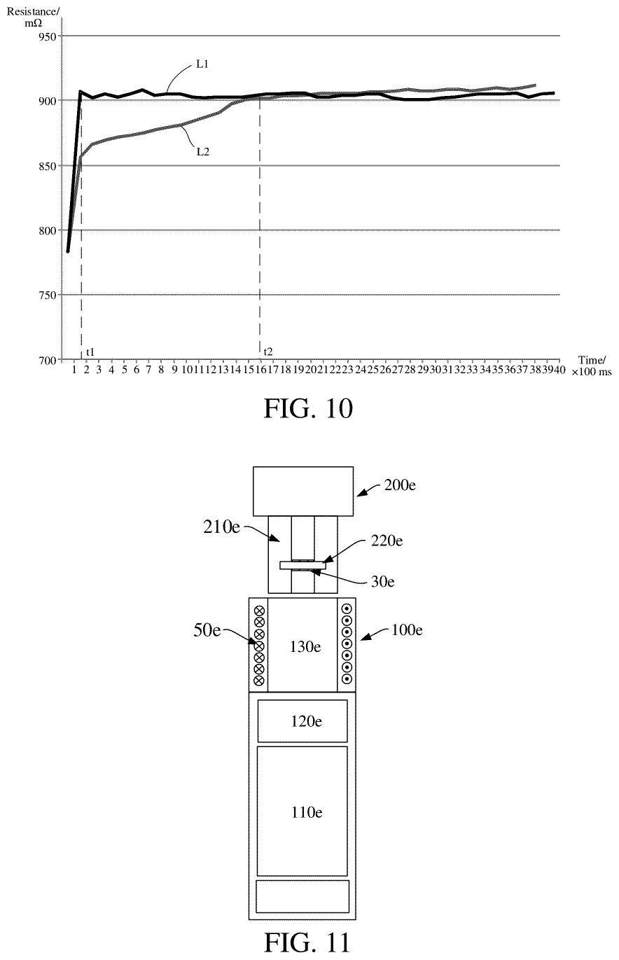

Further, FIG. 9 is a schematic diagram of an operation in which an MCU controller 223 controls providing power to a heating element 40 according to an embodiment. A control process includes:

S10: Determine a current temperature of the heating element 40 by detecting a resistance of the heating element 40.

S20: Determine, based on the current temperature of the heating element 40, power required for heating a temperature of the heating element 40 to a target temperature within a predetermined time period.

S30: Calculate, based on the required power, turn-on time of a switch transistor 222 within the predetermined time period, and control, based on the turn-on time, the switch transistor 222 to be turned on, to provide power to the heating element 40 to heat the temperature of the heating element 40 to the target temperature.

In a specific implementation of the foregoing control process, based on a characteristic of the temperature coefficient of resistance of the heating element 40, the MCU controller 223 may store a correspondence table between the resistance and the temperature of the heating element 40. In operation S10, the temperature of the heating element 40 may be determined through table lookup based on the detected resistance.

In still some specific implementations, in operation S20, the power required for heating to the target temperature is determined based on the current temperature of the heating element 40. The MCU controller 223 may obtain the power through calculation based on an energy conversion formula. In a more preferred implementation, the determining the power required for heating to the target temperature is also obtained based on table lookup. For example, for different atomizers 100, a correspondence table is established in advance for the heating element 40 to be heated from different current temperatures to the target temperature or a difference between the current temperature and the target temperature, and the power required to be consumed, and then the MCU controller 223 may obtain the power required for heating the heating element 40 at the current temperature to the target temperature through table lookup. In some most conventional implementations, the MCU controller 223 controls the turn-on of the switch transistor 222 through a PWM (pulse width) modulation manner, to provide power to the heating element 40. Correspondingly, in a specific implementation of operation S30, the MCU controller 223 controls the turn-on and turn-off time of the switch transistor 222 by adjusting the duty cycle of the PWM modulation, to change a duty cycle of a direct-current voltage or a direct current provided to the heating element 40, so that the power outputted to the heating element 40 is consistent with the required power.

In some specific implementations, during complete inhalation, the foregoing control process is repeated into several predetermined time periods. For example, in complete user inhalation duration of 3 s to 5 s, the MCU controller 223 controls division into several predetermined time periods, and repeatedly performs the foregoing operation S10 to operation S30 to control heating. Duration of each predetermined time period approximately ranges from 1 ms to 100 ms.

In a specific embodiment, with the target temperature T0 being 260° C., an output voltage of the boost unit 221 being 6.0 V, and the initial resistance value of the heating element 40 being 0.783 mΩ, the power provided to the heating element 40 is controlled based on the foregoing operation S10 to operation S30 in several predetermined time periods within inhalation duration of 4 s. Duration of each predetermined time period is set to 20 ms. Further, a curve L1 in FIG. 10 shows a resistance change curve of the heating element 40 when the MCU controller 223 controls the heating element 40 to heat based on the foregoing settings. In addition, the following Table 1 correspondingly shows data of real-time resistance of the heating element 40 and the power provided to the heating element 40:

| Time/ms | Sampled resistance/mΩ | Power/mW |
|---|---|---|
| 0 | 783 | 15662 |
| 100 | 907 | 13604 |
| 200 | 902 | 11004 |
| 300 | 905 | 10956 |
| 400 | 903 | 9835 |
| 500 | 905 | 9813 |
| 600 | 908 | 9205 |
| 700 | 904 | 8668 |
| 800 | 905 | 8635 |
| 900 | 905 | 8635 |
| 1000 | 903 | 8221 |
| 1100 | 902 | 8217 |
| 1200 | 903 | 8208 |
| 1300 | 903 | 8208 |
| 1400 | 903 | 8198 |
| 1500 | 904 | 8176 |
| 1600 | 905 | 8157 |
| 1700 | 905 | 8166 |
| 1800 | 906 | 8148 |
| 1900 | 906 | 8157 |
| 2000 | 903 | 7745 |
| 2100 | 903 | 7732 |
| 2200 | 904 | 7737 |
| 2300 | 904 | 7724 |
| 2400 | 905 | 7715 |
| 2500 | 905 | 7715 |
| 2600 | 902 | 7728 |
| 2700 | 901 | 7737 |
| 2800 | 901 | 7737 |
| 2900 | 901 | 7728 |
| 3000 | 902 | 7719 |
| 3100 | 903 | 7711 |
| 3200 | 904 | 7689 |
| 3300 | 905 | 7681 |
| 3400 | 905 | 7672 |
| 3500 | 905 | 7681 |
| 3600 | 906 | 7664 |
| 3700 | 903 | 7676 |
| 3800 | 905 | 7672 |
| 3900 | 906 | 7651 |

In addition, further, a curve L2 in FIG. 10 shows a resistance change curve of a comparative example in which the MCU controller 223 controls the heating element 40 to heat to the target temperature in a commonly used typical constant power output mode. Similarly, in this comparative example, the target temperature T0 is 260° C., the output power is constant at 7.2 W, and the initial resistance value of the heating element 40 is 0.783 mΩ. In addition, the following Table 2 correspondingly shows data of the real-time resistance of the heating element 40 and the power provided to the heating element 40 during heating in the comparative example:

| Time/ms | Sampled resistance/mΩ | Power/mW |
|---|---|---|
| 0 | 784 | 7200 |
| 100 | 855 | 7200 |
| 200 | 865 | 7200 |
| 300 | 868 | 7200 |
| 400 | 871 | 7200 |
| 500 | 872 | 7200 |
| 600 | 874 | 7200 |
| 700 | 876 | 7200 |
| 800 | 878 | 7200 |
| 900 | 880 | 7200 |
| 1000 | 883 | 7200 |
| 1100 | 886 | 7200 |
| 1200 | 889 | 7200 |
| 1300 | 896 | 7200 |
| 1400 | 899 | 7200 |
| 1500 | 900 | 7200 |
| 1600 | 900 | 7200 |
| 1700 | 902 | 7200 |
| 1800 | 902 | 7200 |
| 1900 | 903 | 7200 |
| 2000 | 904 | 7200 |
| 2100 | 904 | 7200 |
| 2200 | 904 | 7200 |
| 2300 | 904 | 7200 |
| 2400 | 905 | 7200 |
| 2500 | 905 | 7200 |
| 2600 | 906 | 7200 |
| 2700 | 907 | 7200 |
| 2800 | 906 | 7200 |
| 2900 | 906 | 7200 |
| 3000 | 907 | 7200 |
| 3100 | 907 | 7200 |
| 3200 | 906 | 7200 |
| 3300 | 907 | 7200 |
| 3400 | 908 | 7200 |
| 3500 | 907 | 7200 |
| 3600 | 908 | 7200 |
| 3700 | 910 | 7200 |

In the curve L1 obtained by using the control process of the embodiment in FIG. 10, after the resistance rises from an initial state to a target value within about t1 time (0.1 s), the resistance remains substantially stable until the inhalation ends. The correlation between the resistance and the temperature, namely, the curve L1, indicates that after the heating element 40 is heated from a room temperature or the initial temperature to the target temperature within about t1 time (0.15 s), the heating temperature is substantially maintained at the target temperature until the inhalation ends. In addition, it is learned from the foregoing Table 1 that, in a process before the heating element 40 reaches the target temperature, the power provided to the heating element 40 is greater than that in a heat preservation stage. That is, the output power varies with the difference between the current temperature and the target temperature, and is at least non-constant power.

However, in the curve L2 of a heating control manner of outputting in the typical constant power mode, after the resistance rises from the initial state to the target value within about t2 time (1.6 s), the resistance remains stable until the inhalation ends.

It can be seen from the curve L1 of the embodiment and the curve L2 of the comparative example that, heating from the room temperature or initial temperature to the target temperature is faster in the output control mode in the embodiment than in the commonly used constant power output control mode, which is beneficial for quickly generating the aerosol. In addition, in an embodiment, the target temperature is used as a reference for power calculation. Therefore, during heating, whether the supply of the liquid substrate is sufficient or insufficient, the temperature is always maintained at the target temperature, in other words, a “dry burning” situation in which the temperature rises above the target temperature does not occur.

Further, in a more preferred implementation, based on the foregoing detection data in Table 1, the MCU controller 223 further sets the preset power based on the foregoing power required to maintain the target temperature. In addition, when actual power outputted to the heating element 40 does not match the preset power, the adverse condition is determined.

In a specific implementation, the foregoing adverse condition means that the liquid substrate transferred or provided to the heating element 40 is insufficient or that the liquid substrate in the liquid storage cavity 12 is exhausted. Generally, when the liquid substrate provided to the heating element 40 is insufficient or exhausted, the power required to maintain the heating element 40 at the target temperature is lower than the power required to normally atomize the liquid substrate. Then, by monitoring whether the power is lower than the minimum preset power, it may be determined that the liquid substrate provided to the heating element 40 is insufficient or the liquid substrate in the liquid storage cavity 12 is exhausted. For example, according to the test in Table 1, 7.5 W is set as the minimum preset power, and when the power for maintaining the temperature of the heating element 40 at the target temperature of 260° C. is less than the minimum preset power of 7.5 W, it may be considered that the liquid substrate transferred or provided to the heating element 40 is insufficient or the liquid substrate in the liquid storage cavity 12 is exhausted.

In another possible implementation, the foregoing adverse condition is that the atomizer 100 coupled to the power supply mechanism 200 is counterfeit or unqualified or damaged. For a counterfeit or unqualified or damaged atomizer 100, the power provided to maintain the heating element 40 at the target temperature is different from the preset power of a qualified atomizer 100 or exceeds the preset power.

In another possible implementation, the foregoing adverse condition is that the liquid substrate provided by the atomizer 100 to the heating element 40 is undesirable. Specifically, an undesired liquid substrate may have a different composition than a desired liquid substrate, resulting in a different viscosity, heat capacity, boiling point, or the like. In this case, the undesired liquid substrate has a higher or lower temperature or power than expected during heating and atomization. In this case, when the heating element 40 atomizes the undesired liquid substrate, the power required to atomize the undesired liquid substrate is significantly different from the power required to atomize the desired liquid substrate, and whether it is an adverse condition is determined based on the difference in power.

Based on the resistance change curve L1 during actual heating in FIG. 10, during the inhalation, execution frequencies and/or response speeds in the control process of the MCU controller 223 are different corresponding to different heating time periods. In this way, running power consumption of the MCU controller 223 can be reduced while the heating at the target temperature is accurately maintained.

Specifically, in a preferred implementation, the resistance change curve L1 during actual heating shown in FIG. 10 includes:
a first heating time period, that is, a time period 0 to t1, where in this heating time period, the resistance of the heating element 40 reaches a preset value from an initial value; and a second heating time period, that is, t1 to the end of the inhalation, where in this heating time period, the resistance of the heating element 40 is maintained constant.

Alternatively, based on the correlation between the resistance and the temperature, heating the heating element 40 from the initial temperature to the target temperature is defined as the first heating time period, that is, a time period from 0 to t1; and maintaining the temperature of the heating element 40 at the target temperature from t1 to the end of the inhalation is defined as the second heating time period.

In addition, in combination with a calculus control manner of the MCU controller 223, the MCU controller 223 repeatedly performs operation S10 to operation S30 divided into several predetermined time periods in the first heating time period, and finally achieves heating of the heating element 40 to the target temperature in the first heating time period as a whole. Similarly, the MCU controller 223 repeatedly performs operation S10 to operation S30 in several predetermined time periods obtained by dividing the first heating time period, to control the power provided to the heating element 40. Certainly, the target temperature setting in each predetermined time period in the control process is the same or constant.

Further, when the MCU controller 223 repeatedly performs operation S10 to operation S30, the time set in each predetermined time period in the first heating time period is shorter than the time set in each predetermined time period in the second heating time period. For example, in the first heating time period, the MCU controller 223 sets each predetermined time period to 1 ms to 20 ms or less; and in the second heating time period, the MCU controller 223 sets 20 ms to 100 ms or longer for each predetermined time period.

Alternatively, according to the above, the MCU controller 223 controls, in the first heating time period, to perform operation S10 to operation S30 at a higher frequency than that in the second heating time period. Alternatively, the MCU controller 223 controls, in the first heating time period, to perform operation S10 to operation S30 at a response speed faster than that in the second heating time period.

In addition, the MCU controller 223 controls the battery cell 210 to provide power to the heating element 40 in the first heating time period at an output power that is relatively higher than that in the second heating time period. In addition, based on the power data in the foregoing Table 1, the MCU controller 223 controls, in the first heating time period, the output power of the battery cell 210 to be substantially the maximum power that can be outputted by the battery cell 210. For example, in a time period from 0 ms to 100 ms, the output power is 15662 mW, which is basically the maximum power that can be outputted by the battery cell 210.

In addition, based on the specific implementation shown in Table 1, when the maximum power that can be outputted by the battery cell 210 is less than the required power, for example, in a time period from 0 ms to 100 ms in Table 1, the MCU controller 223 controls the battery cell 210 to output at the full maximum power, that is, controls the switch transistor 222 to be fully turned on in this stage until the stage ends.

FIG. 11 shows a schematic diagram of an electronic atomization apparatus according to another embodiment. In this embodiment, the electronic atomization apparatus includes:
an atomizer 200e that stores a liquid aerosol-generating substrate and atomizes the liquid aerosol-generating substrate to generate an aerosol, and a power supply assembly 100e that powers the atomizer 200e. In this embodiment, the aerosol-generating substrate is liquid, and usually includes liquid nicotine or nicotine salt, glycerin, propylene glycol, and the like. When heated, the aerosol-generating substrate atomizes to generate an aerosol that can be inhaled.

The atomizer 200e includes:
a liquid storage cavity 210e, configured to store a liquid aerosol-generating substrate;
a liquid guide element 220e, at least partially extending into the liquid storage cavity 210e to absorb the liquid aerosol-generating substrate; and
an induction heating element 30e, combined with the liquid guide element 220e, to generate heat when penetrated by a changing magnetic field, so as to heat a part of the liquid substrate in the liquid guide element 220e to generate an aerosol. In some optional implementations, the liquid guide element 220e is in a shape of a bar, a tube, a rod, or the like. The liquid guide element 220e may be prepared by using a porous material such as a cotton fiber, a sponge, or a porous ceramic body, to absorb and transfer the liquid aerosol-generating substrate through internal capillary action. The induction heating element 30e may be a receptive strip, tube, mesh, or the like surrounding the liquid guide element 220e.

The power supply assembly 100e includes:
a receiving cavity 130e, arranged at one end in a length direction, where at least a part of the atomizer 200e is removably received in the receiving cavity 130e during use;
an induction coil 50e, at least partially surrounding the receiving cavity 130e, to generate a changing magnetic field;
a battery cell 110e, configured to supply power; and
a circuit board 120e, electrically connected to a rechargeable battery cell 10 in a suitable manner, and configured to convert a direct current outputted by the battery cell 110e into an alternating current with a suitable frequency and supply the alternating current to the induction coil 50e. Power is provided to the induction coil 50e, so that the changing magnetic field is generated by the induction coil 50e, and then magnetic field energy is converted into eddy current heating of the induction heating element 30e, to heat the liquid substrate. The circuit board 120e indirectly provides power to the induction heating element 30e through the induction coil 50e by using power outputted by the battery cell 110e.

Similarly, the circuit board 120e can further control the power outputted to the induction coil 50e by repeatedly performing the foregoing control step S10 to control step S30, so that a temperature of the induction heating element 30e is maintained at a required target temperature.

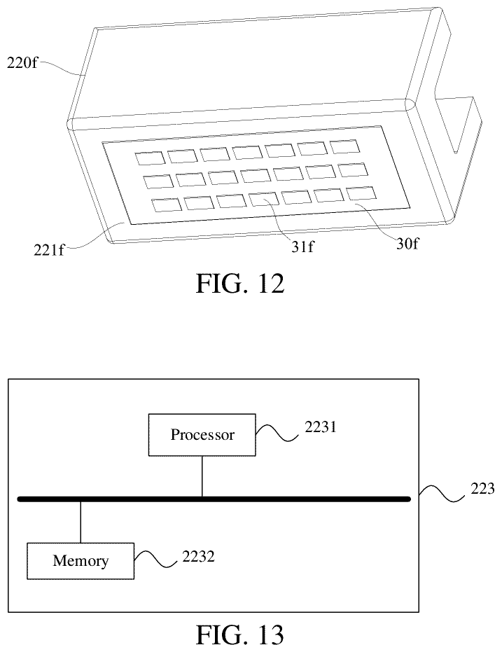

Alternatively, in another optional embodiment, FIG. 12 shows a schematic diagram of a liquid guide element 220f according to another embodiment. At least a part of a surface of the liquid guide element 220f is configured to be in fluid communication with the liquid storage cavity 210e to receive the liquid aerosol-generating substrate. The liquid guide element 220f has a flat extending atomization surface 221f. The induction heating element 30f is combined with the atomization surface 221f by surface mounting, co-sintering, deposition, or the like, and generates heat by being penetrated by the changing magnetic field, to heat the liquid aerosol-generating substrate to generate the aerosol. The induction heating element 30f has a hollow 31f, to define a channel for the aerosol to overflow from the atomization surface 221f. Alternatively, in some implementations, the induction heating element 30f may be in a mesh, a band, a spiral shape, or the like.

In another optional embodiment, the liquid guide element 220f may alternatively be a flat plate, a concave block with a concave cavity on a surface, an arched shape with an arched structure, or the like.

Alternatively, in another optional embodiment, FIG. 13 shows a schematic diagram of a hardware structure of a MCU controller 223 according to another embodiment. As shown in FIG. 13, the MCU controller 223 includes:
one or more processors 2231 and a memory 2232. One processor 2231 is used as an example in FIG. 13.

The processor 2231 and the memory 2232 may be connected by using a bus or in another manner. A connection by using the bus is used as an example in FIG. 13.

The memory 2232, as a non-volatile computer-readable storage medium, may be configured to store a non-volatile software program, a non-volatile computer executable program and a module, such as program instructions/a module corresponding to the control method for an electronic atomization apparatus in the embodiments of this application. The processor 2231 performs various functional applications and data processing of the heating element 40 by running the non-volatile software program, instructions and module stored in the memory 2232, that is, implementing the control method for an electronic atomization apparatus provided in the foregoing method embodiments.

The memory 2232 may include a program storage region and a data storage region. The program storage region may store an operating system and an application that is required for at least one function. The storage data region may store data and the like created according to use of the electronic atomization apparatus. In addition, the memory 2232 may include a high speed random access memory, and may also include a non-volatile memory, such as at least one magnetic disk storage device, a flash memory, or another volatile solid-state storage device.

The foregoing controller may perform the method provided in the embodiments of this application, and have the corresponding functional modules for performing the method and beneficial effects thereof. For technical details not illustrated in this embodiment, reference may be made to the method provided in the embodiments of this application.

The embodiments of this application provide a non-volatile computer-readable storage medium, storing computer executable instructions. The computer executable instructions are executed by one or more processors, for example, one processor 2231 in FIG. 13, so that the foregoing one or more processors may perform the control method for an electronic atomization apparatus in any one of the foregoing method embodiments.

The embodiments of this application provide a computer program product, including a computer program stored in a non-volatile computer-readable storage medium, the computer program including program instructions. When the program instructions are executed by the controller, the controller is enabled to perform the control method for an electronic atomization apparatus in any one of the foregoing method embodiments.

Based on the descriptions of the foregoing implementations, a person of ordinary skill in the art may clearly understand that the implementations may be implemented by software in addition to a universal hardware platform, or by hardware. A person of ordinary skill in the art may understand that, all or some of the processes of the method in the foregoing embodiments may be implemented by a computer program instructing relevant hardware. The program may be stored in a computer-readable storage medium. During execution of the program, the processes of the foregoing method embodiments may be included. The storage medium may be a magnetic disk, an optical disc, a read-only memory (ROM), a random access memory (RAM), or the like.

It should be noted that, the specification of this application and the accompanying drawings thereof illustrate preferred embodiments of this application, but this application is not limited to the embodiments described in the specification. Further, a person of ordinary skill in the art may make improvements or variations according to the foregoing description, and all the improvements and variations shall fall within the protection scope of the appended claims of this application.

1. An electronic atomization apparatus comprising:
a liquid storage cavity configured to store a liquid substrate;
a heating element configured to heat the liquid substrate to generate an aerosol for inhalation;
a battery cell configured to provide a power output; and
a controller, configured to periodically and repeatedly perform a control step, to control the battery cell to directly or indirectly provide power to the heating element, to cause the heating element to heat the liquid substrate,
wherein the control step comprises:
determining a preset target temperature;
obtaining a current temperature of the heating element, and determining, based on the current temperature of the heating element or a difference between the current temperature and the target temperature, power required for the heating element to be heated to the target temperature or maintain the target temperature within a predetermined time period of a single cycle; and
controlling the battery cell to directly or indirectly output the required power to the heating element until the predetermined time period ends, and
wherein the target temperature is constant or unchanged during a process in which the control step is repeatedly performed.

2. The electronic atomization apparatus according to claim 1, further comprising:
a first switch transistor,
wherein the battery cell directly or indirectly provides power to the heating element through the switch transistor; and
wherein the controlling the battery cell to directly or indirectly output the required power to the heating element comprises: determining required turn-on time of the first switch transistor within the predetermined time period based on the required power, and controlling turn-on or turn-off of the first switch transistor based on the required turn-on time.

3. The electronic atomization apparatus according to claim 1, wherein the target temperature ranges from 150° C. to 300° C.

4. The electronic atomization apparatus according to claim 1, wherein the predetermined time period ranges from 1 ms to 100 ms.

5. The electronic atomization apparatus according to claim 1, wherein the controller is configured to:
control, in a first heating time period, the battery cell to provide power to the heating element, to heat a temperature of the heating element from an initial temperature to the target temperature; and
maintain, in a second heating time period, the temperature of the heating element at the target temperature.

6. The electronic atomization apparatus according to claim 5, wherein:
the controller is configured to repeatedly perform the control step at a first frequency in the first heating time period, and repeatedly perform the control step at a second frequency in the second heating time period; and
the first frequency is greater than the second frequency.

7. The electronic atomization apparatus according to claim 5, wherein a predetermined time period during which the control step is performed in the first heating time period is less than a predetermined time period during which the control step is performed in the second heating time period.

8. The electronic atomization apparatus according to claim 5, wherein the controller is configured to control power provided by the battery cell to the heating element in the first heating time period to be greater than power provided to the heating element in the second heating time period.

9. The electronic atomization apparatus according to claim 7, wherein:
the predetermined time period during which the control step is performed in the first heating time period ranges from 1 ms to 20 ms; and/or
the predetermined time period during which the control step is performed in the second heating time period ranges from 20 ms and 100 ms.

10. The electronic atomization apparatus according to claim 1, wherein the controller is further configured to:
determine an adverse condition based on the power provided by the battery cell to the heating element; and
prevent the battery cell from providing power to the heating element when the adverse condition exists.

11. The electronic atomization apparatus according to claim 1, wherein the controller is configured to determine, based on the power provided by the battery cell to the heating element being less than a preset threshold, that the liquid substrate provided to the heating element is insufficient or exhausted.

12. The electronic atomization apparatus according to claim 1, wherein the controller is configured to obtain the current temperature of the heating element by detecting a resistance value of the heating element.

13. The electronic atomization apparatus according to claim 1, further comprising:
a standard voltage divider resistor; and
a second switch transistor, operably connecting the standard voltage divider resistor and the heating element to form a detectable loop in series,
wherein the controller is configured to detect an electrical characteristic of the standard voltage divider resistor and/or the heating element in the detectable loop, to obtain the current temperature of the heating element.

14. The electronic atomization apparatus according to claim 1, further comprising:
a boost unit configured to boost an output voltage of the battery cell.

15. The electronic atomization apparatus according to claim 2, wherein:
the controller is configured to control the turn-on and turn-off of the first switch transistor through pulse width modulation; and
in the control step, the controller is configured to adjust, based on the required turn-on time, a duty cycle of the pulse width modulation to control the turn-on and turn-off of the first switch transistor.

16. The electronic atomization apparatus according to claim 1, wherein the power provided by the battery cell to the heating element is variable or non-constant.

17. A control method for an electronic atomization apparatus, wherein the electronic atomization apparatus comprises:
a liquid storage cavity, configured to store a liquid substrate;
a heating element, configured to heat the liquid substrate to generate an aerosol for inhalation; and
a battery cell, configured to provide a power output,
wherein the method comprises:
periodically and repeatedly performing a control step, to control the battery cell to directly or indirectly provide power to the heating element, to cause the heating element to heat the liquid substrate, wherein the control step comprises:
determining a preset target temperature;
obtaining a current temperature of the heating element, and determining, based on the current temperature of the heating element or a difference between the current temperature and the target temperature, power required for the heating element to be heated to the target temperature or maintain the target temperature within a predetermined time period of a single cycle; and
controlling the battery cell to directly or indirectly output the required power to the heating element until the predetermined time period ends,
wherein the target temperature is constant or unchanged during which the control step is repeatedly performed.

18. A controller comprising:
at least one processor; and
a memory communicatively connected to the at least one processor,
wherein the memory stores instructions executable by the at least one processor, and the instructions are executed by the at least one processor, to cause the at least one processor to be capable of performing the method according to claim 17.

19. A non-volatile computer-readable storage medium, wherein the non-volatile computer-readable storage medium stores computer-executable instructions, the computer-executable instructions, when executed by a controller, causing the controller to perform the method according to claim 17.

20. A computer program product, comprising a computer program stored in a non-volatile computer-readable storage medium, wherein the computer program comprises program instructions, the program instructions, when executed by an electronic device, causing the controller to perform the method according to claim 17.
